(19) United States
(12) Patent Application Publication
(10) Pub. No.: US 2024/0018926 A1
(43) Pub. Date: Jan. 18, 2024

(54) A T AND INVERSE T-SHAPED VALVE FOR AN INLET PORT OF A FUEL INJECTION PUMP

(71) Applicant: Girish Mandakolathur Krishnamurthi, Wildwood, MO (US)

(72) Inventor: Girish Mandakolathur Krishnamurthi, Wildwood, MO (US)

(21) Appl. No.: 17/866,785

(22) Filed: Jul. 18, 2022

(51) Int. Cl. F02M 59/46; F02M 59/02

(52) U.S. Cl. CPC F02M 59/46; F02M 59/02

(57) ABSTRACT

A high-pressure fuel pump is disclosed. The high-pressure fuel pump comprises a housing, and a barrel that is positioned within the housing. A plunger is positioned in a pumping chamber that is defined within the barrel. The plunger is adapted to reciprocate within the pumping chamber that is defined within the barrel to facilitate delivering pressurized fuel from the pumping chamber to a fuel injector. A T-shaped valve and an inverse T-shaped valve are each positioned within a fuel inlet port that is defined in the barrel of the high-pressure fuel pump, the T-shaped valve and the inverse T-shaped valve adapted to regulate a flow of fuel between the pumping chamber and a fuel gallery of the high-pressure fuel pump is also disclosed.

### FIELD OF THE INVENTION

This invention relates generally to a fuel injection pump, and more particularly to a T-shaped valve and an inverse T-shaped valve that are each positioned within a fuel inlet port of the fuel injection pump.

### BACKGROUND OF THE INVENTION

In the current design of a fuel injection pump, pressurized fuel from a low-pressure fuel gallery flows to a pumping chamber via a fuel inlet port that is defined in a barrel of the fuel injection pump. Once the pressurized fuel flows from the fuel gallery to the pumping chamber via the fuel inlet port, a plunger that translates from its bottom dead center position to its top dead center position within the pumping chamber pressurizes the fuel and delivers the pressurized fuel to a fuel injector for injection to an engine cylinder. More specifically, the pressurized fuel from the pumping chamber of the fuel injection pump is channeled to the fuel injector via a fuel delivery valve assembly. The quantity of pressurized fuel that is delivered from the pumping chamber of the fuel injection pump to the fuel injector is controlled by means of a helix groove that is defined in the plunger of the fuel injection pump. The helix groove allows for the flow of pressurized fuel from the pumping chamber of the fuel injection pump to the low-pressure fuel gallery via the fuel inlet port that is defined in the barrel. Therefore, as a load acting on the fuel injection pump is increased from a low load to a high load, the quantity of pressurized fuel that is delivered from the pumping chamber of the fuel injection pump to the fuel injector increases in direct proportion to a stroke length of the plunger from a top edge of the plunger until the helix groove, as the plunger is rotated by means of a mechanical governor. i.e. a quantity of pressurized fuel that is delivered from the pumping chamber of the fuel injection pump to the fuel injector increases in direct proportion to the effective stroke length of the plunger as the top edge of the plunger translates towards its top dead center position from closing the fuel inlet port until the fuel inlet port becomes aligned with the helix groove of the plunger.

However, pressurization of fuel that is present within the pumping chamber of the fuel injection pump begins only after the fuel inlet port is closed by the top edge of the plunger of the fuel injection pump. More specifically, when the plunger translates from its bottom dead center position towards its top dead center position, the pressurized fuel that is present within the pumping chamber is channeled to the fuel gallery via the fuel inlet port until the top edge of the plunger closes the fuel inlet port, with no pressurization of fuel occurring in the pumping chamber of the fuel injection pump. Therefore, energy expended by a roller tappet to displace the plunger from its bottom dead center position until the top edge of the plunger closes the fuel inlet port does not result in any useful work being done by the plunger of the fuel injection pump. As no useful work is being done by the plunger from when the plunger translates from its bottom dead center position until the top edge of the plunger closes the fuel inlet port, a mechanical efficiency of the fuel injection pump is significantly low. A solution is hereby proposed in this manuscript to pressurize the fuel that is present within the pumping chamber of the fuel injection pump from when the plunger translates from its bottom dead center position until the top edge of the plunger closes the fuel inlet port, thereby resulting in an increase in a mechanical efficiency of the fuel injection pump. After the top edge of the plunger closes the fuel inlet port, minimum mechanical energy is expended by the roller tappet for further pressurization of fuel that is present within the pumping chamber of the fuel injection pump until pressurized fuel begins to be delivered to the fuel injector via the fuel delivery valve assembly that is located proximate a cylinder head. Moreover, high temperature residual fuel that remains within the pumping chamber of the fuel injection pump is retained within the pumping chamber itself after fuel delivery from the fuel delivery valve assembly to the fuel injector is complete, thereby decreasing the energy expended by the roller tappet for increasing the temperature of the pressurized fuel that is present in the pumping chamber during the subsequent pressurization stroke of the plunger of the fuel injection pump. The retention of high temperature pressurized fuel within the pumping chamber after the plunger attains its top dead center position engenders a further increase in the mechanical efficiency of the fuel injection pump. An objective of this invention report is to introduce T-shaped and inverse T-shaped spring loaded mechanical valves for regulating a flow of pressurized fuel from the fuel gallery to the pumping chamber, and from the pumping chamber to the fuel gallery with an overall increase in the mechanical efficiency of the fuel injection pump. In an alternate exemplary embodiment, the T-shaped and inverse T-shaped spring loaded mechanical valves may be replaced with a T-shaped valve and an inverse T-shaped valve that may each be actuated via any other mechanism that is known in the art such as an electrical or a pneumatic mechanism.

A traditional fuel injection pump comprises a housing, and a barrel that is positioned within the housing. A plunger is positioned within the pumping chamber that is defined within the barrel and is adapted to reciprocate within the pumping chamber to facilitate delivering pressurized fuel from the pumping chamber of the fuel injection pump to the fuel injector. The quantity of pressurized fuel that is delivered from the fuel injection pump is controlled by means of a helix groove that is defined on an outer circumference of the plunger. More specifically, when the plunger translates to its effective stroke length from its bottom dead center position, the helix groove that is defined on the outer circumference of the plunger is rotated by means of a mechanical governor to align the helix groove with the fuel inlet port that is defined in the barrel of the fuel injection pump. The alignment of the helix groove with the fuel inlet port that is defined in the barrel of the fuel injection pump causes the pressurized fuel from the pumping chamber to be channeled to the fuel gallery via the fuel inlet port until the plunger attains its top dead center position. When the plunger translates towards its bottom dead center position from its top dead center position, pressurized fuel from the fuel gallery flows to the pumping chamber via the fuel inlet port that is defined in the barrel of the fuel injection pump until the plunger attains its bottom dead center position. As the plunger begins its ascent towards its top dead center position from its bottom dead center position, the pressurized fuel from the pumping chamber is channeled back to the fuel gallery via the fuel inlet port until the top edge of the plunger closes the fuel inlet port. Once the fuel inlet port is closed by the top edge of the plunger, pressurization of the fuel within the pumping chamber of the fuel injection pump begins. As the plunger continues ascending beyond the displacement where the top edge of the plunger closes the fuel inlet port, the pressure of the fuel within the pumping chamber continues increasing until the pressure of the fuel in the pumping chamber attains its fuel delivery valve pin opening pressure. Consequently, the fuel that is channeled from the pumping chamber to the fuel gallery from the point when the plunger begins its ascent from its bottom dead center position until the top edge of the plunger closes the fuel inlet port is not utilized for pressurization and delivery to the fuel injector via the fuel delivery valve assembly. Moreover, from the point when the plunger begins its ascent from its bottom dead center position until the top edge of the plunger closes the fuel inlet port, energy expended by a cam-shaft to translate the plunger by this displacement is not utilized for pressurization and delivery of fuel from the pumping chamber of the fuel injection pump to the feel injector via the fuel delivery valve assembly. Therefore, the mechanical efficiency of the fuel injection pump is low. Consequently, there exists a need for a fuel regulating mechanism that would enable a substantial portion of the fuel that is within the pumping chamber to be retained within the pumping chamber itself from when the plunger begins its ascent from its bottom dead center position until the top edge of the plunger closes the fuel inlet port, thereby allowing the retained fuel to be pressurized as well as allowing the plunger to perform useful work by pressurizing the fuel in the pumping chamber during this period of displacement of the plunger within the pumping chamber.

The need has existed for many years, yet there is no fully satisfactory system to meet the need. In accord with a long recognized need, there has been developed a T and inverse T-shaped valve that when positioned within the fuel inlet port that is defined in the barrel regulates a flow of pressurized fuel between the fuel gallery and the pumping chamber of the fuel injection pump. The T and inverse T-shaped valve that is positioned within the fuel inlet port that is defined in the barrel is designed to increase the mechanical efficiency of the fuel injection pump by allowing the plunger to perform useful work, as well as pressurizing the fuel in the pumping chamber from when the plunger begins its ascent from its bottom dead center position until the top edge of the plunger closes the fuel inlet port. By pre-pressurizing the fuel within the pumping chamber from when the plunger begins its ascent from its bottom dead center position until the top edge of the plunger closes the fuel inlet port, the volume of the pumping chamber that is required to pressurize the fuel after the top edge of the plunger closes the fuel inlet port may be substantially decreased/eliminated. Due to a decrease in the volume of the pumping chamber that is required to pressurize the fuel after the top edge of the plunger closes the fuel inlet port, the dimensions of the fuel injection pump may be substantially decreased. The T and inverse T-shaped valve is compact and can fit snugly within the fuel inlet port that is defined in the barrel of the fuel injection pump during an assembly process of the fuel injection pump.

### BRIEF DESCRIPTION OF THE INVENTION

In one aspect of the invention, a method of assembling a component within a barrel of a high-pressure fuel pump is described. The method comprises positioning the component comprising a T-shaped valve within a fuel inlet port that is defined in the barrel of the high-pressure fuel pump. The T-shaped valve is adapted to regulate a flow of fuel between a fuel gallery and a pumping chamber of the high-pressure fuel pump.

In another aspect of the invention, a high-pressure fuel pump is described. The high-pressure fuel pump comprises a housing, and a barrel that is positioned within the housing. A plunger is positioned in a pumping chamber that is defined within the barrel. The plunger is adapted to reciprocate within the pumping chamber to facilitate delivering pressurized fuel from the pumping chamber to at least one fuel injector. A first T-shaped valve is positioned within a fuel inlet port that is defined in the barrel of the high-pressure fuel pump. The first T-shaped valve is adapted to regulate a flow of fuel between a fuel gallery and the pumping chamber of the high-pressure fuel pump.

In a further aspect of the invention, a barrel that is positioned within a housing of a high-pressure fuel pump is described. The barrel comprises a first T-shaped valve that is positioned within a fuel inlet port that is defined in the barrel of the high-pressure fuel pump. The first T-shaped valve is adapted to regulate a flow of fuel between a fuel gallery and a pumping chamber of the high-pressure fuel pump.

### BRIEF DESCRIPTION OF THE DRAWINGS

FIG. 1 is a schematic representation of a high-pressure fuel pump comprising a plunger, and a T and inverse T-shaped valve that are each positioned within a fuel inlet port of the high-pressure fuel pump in one embodiment of the invention.

FIG. 2 is a schematic representation of a T-shaped valve and an inverse T-shaped valve that are each positioned within a fuel inlet port of a barrel of the high-pressure fuel pump shown in FIG. 1 in one embodiment of the invention.

FIG. 3 is a flowchart representing a method of assembling a component within a barrel of a high-pressure fuel pump in one embodiment of the invention.

### DETAILED DESCRIPTION OF THE INVENTION

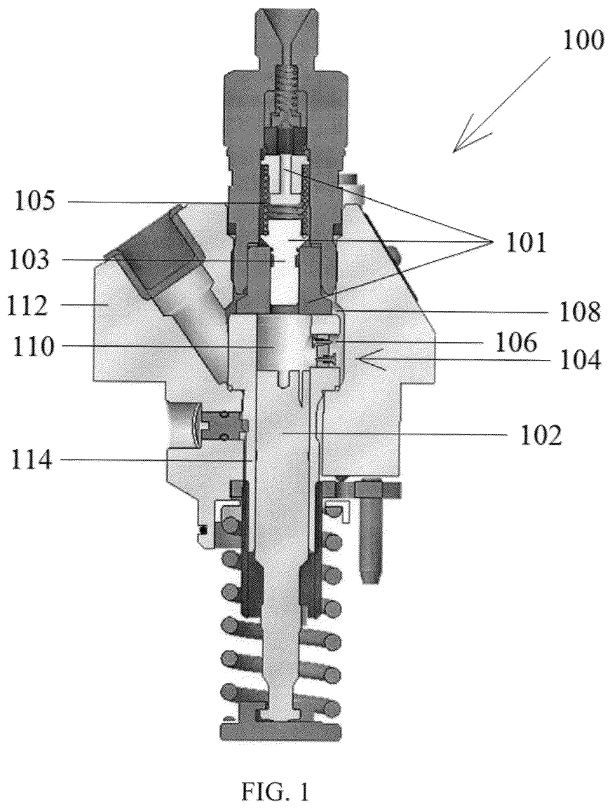

FIG. 1 is a schematic representation of a high-pressure fuel pump 100 comprising a plunger 102 and a T and inverse T-shaped valve 104 that are each positioned within a fuel inlet port 106 of the high-pressure fuel pump 100 that regulate a flow of pressurized fuel from a fuel gallery 108 to a pumping chamber 110, and from the pumping chamber 110 back to the fuel gallery 108 respectively. More specifically, the T and inverse T-shaped valve 104 is in flow communication with pressurized fuel that is present in the fuel gallery 108 by being positioned within the fuel inlet port 106 of the high-pressure fuel pump 100, and is adapted to regulate the flow of pressurized fuel from the fuel gallery 108 to the pumping chamber 110. Similarly, the T and inverse T-shaped valve 104 is in flow communication with pressurized fuel that is present in the pumping chamber 110 of the high-pressure fuel pump 100 by being positioned within the fuel inlet port 106 of the high-pressure fuel pump 100, and is adapted to regulate the flow of pressurized fuel from the pumping chamber 110 to the fuel gallery 108 of the high-pressure fuel pump 100.

FIG. 1 illustrates a high-pressure fuel pump 100, and more specifically to a T and inverse T-shaped valve 104 that are each positioned within a fuel inlet port 106 of the high-pressure fuel pump 100. The high-pressure fuel pump 100 comprises a housing 112. A barrel 114 is positioned within the housing 112 and is thereby secured to the housing 112. In an exemplary embodiment, the barrel 114 comprises the pumping chamber 110 that is defined within a body of the barrel 114 and is adapted to house the plunger 102 therein. The fuel inlet port 106 is defined through a sidewall of the barrel 114 and is adapted to extend from the pumping chamber 110 at its one end to the fuel gallery 108 at its opposite second end. The fuel gallery 108 is defined proximate to an outer sidewall of the barrel 114. The plunger 102 is adapted to reciprocate within the pumping chamber 110 from a bottom dead center position to a top dead center position, and from the top dead center position to the bottom dead center position respectively to facilitate delivering pressurized fuel for each stroke of the plunger 102 from the pumping chamber 110 of the high-pressure fuel pump 100 to a fuel injector (not shown) via a fuel delivery valve assembly 101 that is positioned at an outlet of the high-pressure fuel pump 100. The fuel delivery valve assembly 101 is a spring actuated module of the high-pressure fuel pump 100. More specifically, when the pressure of the fuel that is present within the pumping chamber 110 exceeds a pressure of fuel required to displace a spring member 105 of a fuel delivery valve pin 103 of the fuel delivery valve assembly 101, the fuel delivery valve pin 103 is actuated away from the pumping chamber 110 against a resistive force of its spring member 105. The actuation of the fuel delivery valve pin 103 against the resistive force of its spring member 105 causes pressurized fuel from the pumping chamber 110 to be channeled to the fuel injector. At the end of fuel injection, when the pressure of the fuel that is within the pumping chamber 110 decreases below the pressure of fuel required to displace the spring member 105 of the fuel delivery valve pin 103, the fuel delivery valve pin 103 is actuated towards the pumping chamber 110 due to a restoring force of its spring member 105. The core idea of this invention is to introduce a spring actuated T and inverse T-shaped valve 104 within the fuel inlet port 106 that is defined in the barrel 114 of the high-pressure fuel pump 100 as is shown in FIG. 1.

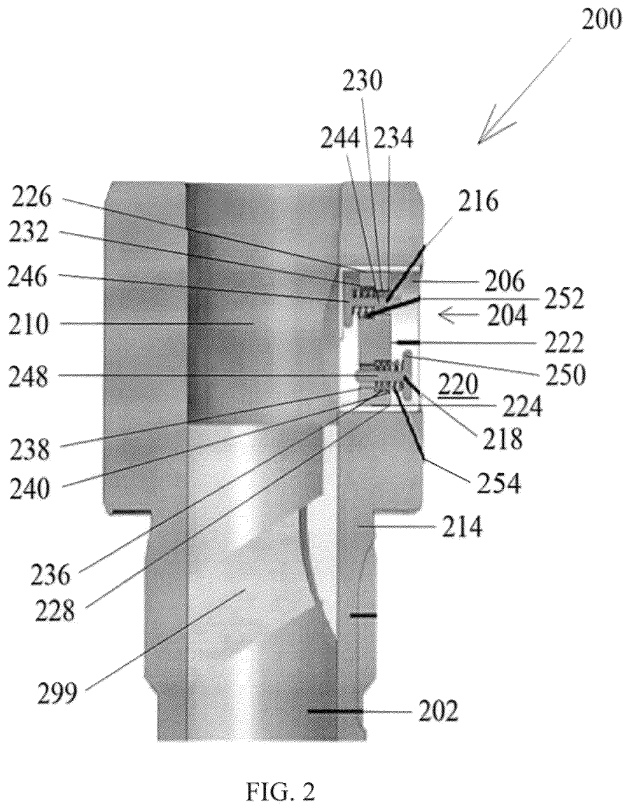

FIG. 2 is a schematic representation of a T and inverse T-shaped valve 204 that are positioned within a fuel inlet port 206 of a sectioned high-pressure fuel pump 200 in one embodiment of the invention. In an exemplary embodiment, the barrel 214 comprises a first T-shaped valve 216 that is positioned within the fuel inlet port 206 that is defined in the barrel 214 of the high-pressure fuel pump 200. More specifically, the first T-shaped valve 216 is positioned within the fuel inlet port 206 that is defined in the barrel 214 of the high-pressure fuel pump 200. The first T-shaped valve 216 is adapted to regulate a flow of pressurized fuel between the fuel gallery 220 and the pumping chamber 210 of the high-pressure fuel pump 200. The first T-shaped valve 216 may be manufactured from any material that is known in the art that allows the first T-shaped valve 216 to function in a manner that is described in more detail below. The first T-shaped valve 216 may be manufactured from but is not limited to a mild steel material, an alloy, and a composite material.

In an exemplary embodiment, the high-pressure fuel pump 200 further comprises a second T-shaped valve 218 that is positioned within the fuel inlet port 206 that is defined in the barrel 214 of the high-pressure fuel pump 200. More specifically, the second T-shaped valve 218 is adapted to regulate the flow of pressurized fuel between the pumping chamber 210 and the fuel gallery 220 of the high-pressure fuel pump 200. The second T-shaped valve 218 may be manufactured from any material that is known in the art that allows the second T-shaped valve 218 to function in a manner that is described in more detail below. The second T-shaped valve 218 may be manufactured from but is not limited to a mild steel material, an alloy, and a composite material.

The fuel inlet port 206 of the high-pressure fuel pump 200 is defined in the barrel 214 of the high-pressure fuel pump 200 and is in flow communication with the fuel gallery 220 at its one end. An opposite second end of the fuel inlet port 206 is in flow communication with the pumping chamber 210 of the high-pressure fuel pump 200. Therefore, the fuel inlet port 206 of the high-pressure fuel pump 200 which constitutes a single modular flow chamber is located between the fuel gallery 220 at its one end and the pumping chamber 210 at its opposite second end. In an alternate exemplary embodiment, the fuel inlet port 206 of the high-pressure fuel pump 200 constitutes multiple discrete flow chambers that are each located between the fuel gallery 220 at its one end and the pumping chamber 210 at its opposite second end. An axis of the fuel inlet port 206 is substantially perpendicular to a longitudinal axis of the high-pressure fuel pump 200. The fuel inlet port 206 allows for the flow of pressurized fuel from the fuel gallery 220 to the pumping chamber 210, and from the pumping chamber 210 to the fuel gallery 220 of the high-pressure fuel pump 200 respectively. In an exemplary embodiment, an orifice plate 222 is positioned within the fuel inlet port 206 and is secured to a circumferential wall 224 of the fuel inlet port 206. The orifice plate 222 that is positioned within the fuel inlet port 206 is secured at its diametrically opposite extreme ends (226,228) to the circumferential wall 224 of the fuel inlet port 206. More specifically, the orifice plate 222 is secured at its two opposite diametrically extreme ends (226,228) to the circumferential wall 224 of the fuel inlet port 206 by means of a mechanical fastener. In an alternate exemplary embodiment, the orifice plate 222 is secured at its two opposite diametrically extreme ends (226,228) to the circumferential wall 224 of the fuel inlet port 206 by welding the two opposite diametrically extreme ends (226,228) of the orifice plate 222 to the circumferential wall 224 of the fuel inlet port 206. In another alternate exemplary embodiment, the orifice plate 222 is secured at its two opposite diametrically extreme ends (226,228) to the circumferential wall 224 of the fuel inlet port 206 during a casting process of the barrel 214 of the high-pressure fuel pump 200. In yet another alternate exemplary embodiment, the orifice plate 222 may be integrally formed with the circumferential wall 224 of the fuel inlet port 206 at its two opposite diametrically extreme ends (226,228) and therefore constitutes an integral assembly with the barrel 214 of the high-pressure fuel pump 200.

In an exemplary embodiment, the orifice plate 222 comprises a first orifice 230 that defined in the orifice plate 222 and is located between the fuel gallery 220 and the pumping chamber 210 of the high-pressure fuel pump 200. More specifically, the first orifice 230 that is defined in the orifice plate 222 originates from a first end 232 of the orifice plate 222 that faces the pumping chamber 210 of the high-pressure fuel pump 200 and terminates at an opposite second end 234 of the orifice plate 222 that faces the fuel gallery 220 of the high-pressure fuel pump 200. In an exemplary embodiment, the orifice plate 222 comprises a second orifice 236 that is defined in the orifice plate 222 and is located between the fuel gallery 220 and the pumping chamber 210 of the high-pressure fuel pump 200. More specifically, the second orifice 236 that is defined in the orifice plate 222 originates from a first end 238 of the orifice plate 222 that faces the pumping chamber 210 of the high-pressure fuel pump 200 and terminates at an opposite second end 240 of the orifice plate 222 that faces the fuel gallery 220 of the high-pressure fuel pump 200. The first orifice 230 and the second orifice 236 of the orifice plate 222 each extend between opposite end faces of the orifice plate 222, and are therefore located between the pumping chamber 210 and the fuel gallery 220 of the high-pressure fuel pump 200 respectively. In an exemplary embodiment, an axial displacement between the first orifice 230 and the second orifice 236 that each extend between opposite end faces of the orifice plate 222 may be user defined based on a user specific application. Moreover, a diameter of the first orifice 230 and a diameter of the second orifice 236 that each extend between opposite end faces of the orifice plate 222 may be user defined based on the user specific application.

In an exemplary embodiment, the first orifice 230 and the second orifice 236 that are each defined in the orifice plate 222 and are bored between opposite end faces of the orifice plate 222 may each extend linearly along an axis of the fuel inlet port 206 from the first end (232,238) of the orifice plate 222 that faces the pumping chamber 210 to the opposite second end (234,240) of the orifice plate 222 that faces the fuel gallery 220 of the high-pressure fuel pump 200. In an alternate exemplary embodiment, the first orifice 230 and the second orifice 236 that am each defined in the orifice plate 222 and are bored between opposite end faces of the orifice plate 222 may taper linearly from their first ends (232,238) of the orifice plate 222 that faces the pumping chamber 210 to their opposite second ends (234,240) of the orifice plate 222 that faces the fuel gallery 220 of the high-pressure fuel pump 200. More specifically, the second end 234 of the first orifice 230 that is in flow communication with the fuel gallery 220 may have a smaller diameter, while the opposite first end 232 of the first orifice 230 that is in flow communication with the pumping chamber 210 may have a larger diameter or vice versa. Similarly, the second end 240 of the second orifice 236 that is in flow communication with the fuel gallery 220 may have a larger diameter, while the opposite first end 238 of the second orifice 236 that is in flow communication with the pumping chamber 210 may have a smaller diameter or vice versa.

In an exemplary embodiment, the first T-shaped valve 216 regulates a flow of pressurized fuel from the fuel gallery 220 to the pumping chamber 210 of the high-pressure fuel pump 200. The first T-shaped valve 216 comprises a first stem portion 244 that extends/inserted through the orifice plate 222 towards the fuel gallery 220 of the high-pressure fuel pump 200 from the pumping chamber 210 and reciprocates within the first orifice 230 to facilitate regulating the flow of pressurized fuel from the fuel gallery 220 to the pumping chamber 210 of the high-pressure fuel pump 200. A first T-shaped portion 246 of the first T-shaped valve 216 is formed at an end of the first stem portion 244 of the first T-shaped valve 216. More specifically, the first T-shaped portion 246 of the first T-shaped valve 216 is positioned against the first end 232 of the first orifice 230 that is in flow communication with the pumping chamber 210 such that the first T-shaped portion 246 of the first T-shaped valve 216 closes the first orifice 230 that is in flow communication with the pumping chamber 210.

When the first T-shaped valve 216 is displaced away from the opposite second end 234 of the first orifice 230 due to pressurized fuel from the fuel gallery 220 acting on the first T-shaped portion 246 of the first T-shaped valve 216, the fuel gallery 220 and the pumping chamber 210 are in flow communication with one another. Pressurized fuel from the fuel gallery 220 is allowed to flow through the fuel inlet port 206 and to the pumping chamber 210 past the first T-shaped portion 246 of the first T-shaped valve 216 until the first T-shaped portion 246 of the first T-shaped valve 216 is positioned flush against the first end 232 of the first orifice 230 that is in flow communication with the pumping chamber 210. Once the first T-shaped portion 246 of the first T-shaped valve 216 is positioned flush against the first end 232 of the first orifice 230, the pressurized fuel that is present in the fuel gallery 220 is retained within the fuel gallery 220 and is not allowed to flow to the pumping chamber 210 of the high-pressure fuel pump 200 via the fuel inlet port 206 and via the first orifice 230. When the first T-shaped valve 216 is displaced away from the opposite second end 234 of the first orifice 230, the first T-shaped portion 246 of the first T-shaped valve 216 extends within the fuel inlet port 206 itself and not allowed to extend to the pumping chamber 210 of the high-pressure fuel pump 200 to prevent the plunger 202 from coming in contact with the first T-shaped portion 246 of the first T-shaped valve 216.

In an exemplary embodiment, the second T-shaped valve 218 regulates a flow of pressurized fuel from the pumping chamber 210 to the fuel gallery 220 of the high-pressure fuel pump 200. The second T-shaped valve 218 comprises a second stem portion 248 that extends/inserted through the orifice plate 112 towards the pumping chamber 210 of the high-pressure fuel pump 200 from the fuel gallery 220 and reciprocates within the second orifice 236 to facilitate regulating the flow of pressurized fuel from the pumping chamber 210 to the fuel gallery 220 of the high-pressure fuel pump 200. A second T-shaped portion 250 of the second T-shaped valve 218 is formed at the end of the second stem portion 248 of the second T-shaped valve 218. More specifically, the second T-shaped portion 250 of the second T-shaped valve 218 is positioned against the opposite second end 240 of the second orifice 236 that is in flow communication with the fuel gallery 220 such that the second T-shaped portion 250 of the second T-shaped valve 218 closes the second orifice 236 that is in flow communication with the fuel gallery 220.

When the second T-shaped valve 218 is displaced away from the first end 238 of the second orifice 236 due to pressurized fuel from the pumping chamber 210 acting on the second T-shaped portion 250 of the second T-shaped valve 218, the pumping chamber 210 and the fuel gallery 220 are in flow communication with one another. Pressurized fuel from the pumping chamber 210 is allowed to flow through the fuel inlet port 206 and to the fuel gallery 220 past the second T-shaped portion 250 of the second T-shaped valve 218 until the second T-shaped portion 250 of the second T-shaped valve 218 is positioned flush against the opposite second end 240 of the second orifice 236 that is in flow communication with the fuel gallery 220. Once the second T-shaped portion 250 of the second T-shaped valve 218 is positioned flush against the opposite second end 240 of the second orifice 236, the pressurized fuel that is present in the pumping chamber 210 is retained within the pumping chamber 210 and is not allowed to flow to the fuel gallery 220 of the high-pressure fuel pump 200 via the fuel inlet port 206 and via the second orifice 236. When the second T-shaped valve 218 is displaced away from the first end 238 of the second orifice 236, the second T-shaped portion 250 of the second T-shaped valve 218 extends within the fuel inlet port 206 itself and not allowed to extend to the fuel gallery 220 of the high-pressure fuel pump 200. Therefore, since the first T-shaped valve 216 allows the pressurized fuel to flow from the fuel gallery 220 to the pumping chamber 210 of the high-pressure fuel pump 200, and the second T-shaped valve 218 allows the pressurized fuel to flow from the pumping chamber 210 to the fuel gallery 220 of the high-pressure fuel pump 200, a direction of orientation of the second T-shaped valve 218 is opposite to a direction of orientation of the first T-shaped valve 216 to constitute a T and inverse T-shaped valve assembly in combination with the orifice plate 222.

In an exemplary embodiment, the first T-shaped valve 216 is adapted to open/close the first orifice 230 of the orifice plate 222, thereby regulating the flow of pressurized fuel from the fuel gallery 220 to the pumping chamber 210 of the high-pressure fuel pump 200. More specifically, the first T-shaped valve 216 is adapted to open/close the first end 232 of the first orifice 230 that is in flow communication with the pumping chamber 210 such that the first T-shaped portion 246 of the first T-shaped valve 216 opens/closes the first orifice 230 that is in flow communication with the pumping chamber 210, thereby regulating the flow of pressurized fuel from the fuel gallery 220 to the pumping chamber 210 of the high-pressure fuel pump 200. Moreover, in an exemplary embodiment, the second T-shaped valve 218 is adapted to open/close the second orifice 236 of the orifice plate 222, thereby regulating the flow of pressurized fuel from the pumping chamber 210 to the fuel gallery 220 of the high-pressure fuel pump 200. More specifically, the second T-shaped valve 218 is adapted to open/close the second end 240 of the second orifice 236 that is in flow communication with the fuel gallery 220 such that the second T-shaped portion 250 of the second T-shaped valve 218 opens/closes the second orifice 236 that is in flow communication with the fuel gallery 220, thereby regulating the flow of pressurized fuel from the pumping chamber 210 to the fuel gallery 220 of the high-pressure fuel pump 200.

In an exemplary embodiment, a first spring member 252 is positioned between the first orifice 230 that is defined in the orifice plate 222 and the first T-shaped valve 216. More specifically, the first spring member 252 is positioned between an end of a first bore that extends from the first end 232 of the first orifice 230 to a first portion within the orifice plate 222 and the first T-shaped portion 246 of the first T-shaped valve 216. Therefore, when the first T-shaped portion 246 of the first T-shaped valve 216 is firmly positioned against the first end 232 of the first orifice 230, the first spring member 252 is compressed within the first bore that extends from the first end 232 of the first orifice 230 to the first portion within the orifice plate 222. In this state, no portion of the first spring member 252 extends out of the first bore towards the pumping chamber 210 and is therefore retained within the first bore that extends from the first end 232 of the first orifice 230 to the first portion within the orifice plate 222, thereby allowing a tight sealing arrangement between the first T-shaped portion 246 of the first T-shaped valve 216 that is proximate to the first spring member 252 and the first end 232 of the first orifice 230. The tight sealing arrangement between the first T-shaped portion 246 of the first T-shaped valve 216 that is proximate to the first spring member 252 against the first end 232 of the first orifice 230 prevents fuel flow from the fuel gallery 220 to the pumping chamber 210 of the high-pressure fuel pump 200.

Therefore, in its equilibrium position when the first spring member 252 is not extended, the first T-shaped portion 246 of the first T-shaped valve 216 is flush against the first end 232 of the first orifice 230 of the orifice plate 222. When an algebraic difference between the pressure of the pressurized fuel in the fuel gallery 220 and the pressure of the pressurized fuel in the pumping chamber 210 of the high-pressure fuel pump 200 exceeds the pressure of fuel required to displace the first spring member 252, the first T-shaped valve 216 is displaced towards the pumping chamber 210. More specifically, the first T-shaped portion 246 of the first T-shaped valve 216 is displaced towards the pumping chamber 210 against the resistive force of the first spring member 252 that is positioned between the first T-shaped portion 246 of the first T-shaped valve 216 and the first portion within the orifice plate 222. The displacement of the first T-shaped valve 216 against the resistive force of the first spring member 252 towards the pumping chamber 210 causes the first orifice 230 to be opened. Pressurized fuel from the fuel gallery 220 is therefore allowed to be channeled to the pumping chamber 210 of the high-pressure fuel pump 200 until the first T-shaped portion 246 of the first T-shaped valve 216 is flush against the first end 232 of the first orifice 230 of the orifice plate 222.

When the differential pressure of the fuel between the fuel in the fuel gallery 220 and the fuel in the pumping chamber 210 of the high-pressure fuel pump 200 decreases below the pressure of fuel required to displace the first spring member 252, the first T-shaped valve 216 is displaced towards the fuel gallery 220. More specifically, the first T-shaped portion 246 of the first T-shaped valve 216 is displaced towards the fuel gallery 220 due to the restoring force that is exerted by the first spring member 252 that is positioned between the T-shaped portion 246 of the first T-shaped valve 216 and the first portion within the orifice plate 222 on the first T-shaped valve 216. The displacement of the first T-shaped valve 216 due to the restoring force that is exerted by the first spring member 252 towards the fuel gallery 220 causes the first T-shaped portion 246 of the first T-shaped valve 216 to be flush against the first end 232 of the first orifice 230 that is in flow communication with the pumping chamber 210 of the high-pressure fuel pump 200.

When the first T-shaped portion 246 of the first T-shaped valve 216 is flush against the first end 232 of the first orifice 230, the first orifice 230 is closed thereby preventing the flow of pressurized fuel from the fuel gallery 220 from being channeled to the pumping chamber 210 of the high-pressure fuel pump 200. Therefore, in its equilibrium position, when the differential pressure of fuel between the fuel gallery 220 and the pumping chamber 210 is lower than the pressure of fuel required to displace the first spring member 252, the first spring member 252 is adapted to displace the first T-shaped portion 246 of the first T-shaped valve 216 against the first end 232 of the first orifice 230, thereby closing the first end 232 of the first orifice 230 and preventing the flow of pressurized fuel from the fuel gallery 220 to the pumping chamber 210 of the high-pressure fuel pump 200.

In an exemplary embodiment, a second spring member 254 is positioned between the second orifice 236 that is defined in the orifice plate 222 and the second T-shaped valve 218. More specifically, the second spring member 254 is positioned between an end of a second bore that extends from the second end 240 of the second orifice 236 to a second portion within the orifice plate 222 and the second T-shaped portion 250 of the second T-shaped valve 218. Therefore, when the second T-shaped portion 250 of the second T-shaped valve 218 is firmly positioned against the second end 240 of the second orifice 236, the second spring member 254 is compressed within the second bore that extends from the second end 240 of the second orifice 236 to the second portion within the orifice plate 222. In this state, no portion of the second spring member 254 extends out of the second bore towards the fuel gallery 220 and is therefore retained within the second bore that extends from the second end 240 of the second orifice 236 to the second portion within the orifice plate 222, thereby allowing a tight sealing arrangement between the second T-shaped portion 250 of the second T-shaped valve 218 that is proximate to the second spring member 254 against the second end 240 of the second orifice 236. The tight sealing arrangement between the second T-shaped portion 250 of the second T-shaped valve 218 that is proximate to the second spring member 254 and the second end 240 of the second orifice 236 prevents fuel flow from the pumping chamber 210 to the fuel gallery 220 of the high-pressure fuel pump 200.

Therefore, in its equilibrium position when the second spring member 254 is not extended, the second T-shaped portion 250 of the second T-shaped valve 218 is flush against the second end 240 of the second orifice 236 of the orifice plate 222. When an algebraic difference between the pressure of the fuel in the pumping chamber 210 and the pressure of the fuel in the fuel gallery 220 of the high-pressure fuel pump 200 exceeds the pressure of fuel required to displace the second spring member 254, the second T-shaped valve 218 is displaced towards the fuel gallery 220. More specifically, the second T-shaped portion 250 of the second T-shaped valve 218 is displaced towards the fuel gallery 220 against the resistive force of the second spring member 254 that is positioned between the second T-shaped portion 250 of the second T-shaped valve 218 and the second portion within the orifice plate 222. The displacement of the second T-shaped valve 218 against the resistive force of the second spring member 254 towards the fuel gallery 220 causes the second orifice 236 to be opened. Pressurized fuel from the pumping chamber 210 is therefore channeled to the fuel gallery 220 of the high-pressure fuel pump 200 until the second T-shaped portion 250 of the second T-shaped valve 218 is flush against the second end 240 of the second orifice 236 of the orifice plate 222.

When the differential pressure of the fuel between the fuel in the pumping chamber 210 and the fuel in the fuel gallery 220 of the high-pressure fuel pump 200 decreases below the pressure of fuel required to displace the second spring member 254, the second T-shaped valve 218 is displaced towards the pumping chamber 210. More specifically, the second T-shaped portion 250 of the second T-shaped valve 218 is displaced towards the pumping chamber 210 due to the restoring force that is exerted by the second spring member 254 that is positioned between the T-shaped portion 250 of the second T-shaped valve 218 and the second portion within the orifice plate 222 on the second T-shaped valve 218. The displacement of the second T-shaped valve 218 due to the restoring force that is exerted by the second spring member 254 towards the pumping chamber 210 causes the second T-shaped portion 250 of the second T-shaped valve 218 to be flush against the second end 240 of the second orifice 236 that is in flow communication with the fuel gallery 220 of the high-pressure fuel pump 200.

When the second T-shaped portion 250 of the second T-shaped valve 218 is flush against the second end 240 of the second orifice 236, the second orifice 236 is closed thereby preventing the flow of pressurized fuel from the pumping chamber 210 to the fuel gallery 220 of the high-pressure fuel pump 200. Therefore, in its equilibrium position, when the differential pressure of fuel between the pumping chamber 210 and the fuel gallery 220 is lower than the pressure of fuel required to displace the second spring member 254, the second spring member 254 is adapted to displace the second T-shaped portion 250 of the second T-shaped valve 21g against the second end 240 of the second orifice 236, thereby closing the second end 240 of the second orifice 236 and preventing the flow of pressurized fuel from the pumping chamber 210 to the fuel gallery 220 of the high-pressure fuel pump 200.

In an exemplary embodiment, the first spring member 252 is positioned between the first orifice 230 that is defined in the orifice plate 222 and the first T-shaped valve 216. In the exemplary embodiment, the first spring member 252 is adapted to displace the first T-shaped valve 216 against the first end 232 of the first orifice 230 to facilitate closing the first end 232 of the first orifice 230. More specifically, when a pressure differential between the pressurized fuel in the fuel gallery 220 and the pressurized fuel in the pumping chamber 210 exceeds the pressure of fuel required to displace the first spring member 252, the first T-shaped valve 216 is displaced towards the pumping chamber 210 against the resistive force of the first spring member 252. The displacement of the first T-shaped valve 216 towards the pumping chamber 210 causes the first orifice 230 that is defined in the orifice plate 222 to open due to an algebraic difference in pressure of fuel between fuel in the fuel gallery 220 and fuel in the pumping chamber 210. The opening of the first orifice 230 causes pressurized fuel from the fuel gallery 220 to be channeled through the first orifice 230 and to the pumping chamber 210 of the high-pressure fuel pump 200.

The process of fuel flow from the fuel gallery 220 to the pumping chamber 210 of the high-pressure fuel pump 200 continues until the pressure differential between the pressurized fuel in the fuel gallery 220 and the pressurized fuel in the pumping chamber 210 decreases below the pressure of fuel required to displace the first spring member 252. Therein, the first spring member 252 is adapted to displace the first T-shaped portion 246 of the first T-shaped valve 216 against the first end 232 of the rust orifice 230, thereby closing the first end 232 of the first orifice 230. The closure of the first end 232 of the first orifice 230 ensures that the pressurized fuel that is present within the fuel gallery 220 is retained within the fuel gallery 220 of the high-pressure fuel pump 200 itself without flowing to the pumping chamber 210.

In an exemplary embodiment, the second spring member 254 is positioned between the second orifice 236 that is defined in the orifice plate 222 and the second T-shaped valve 218. In the exemplary embodiment, the second spring member 254 is adapted to displace the second T-shaped valve 218 against the second end 240 of the second orifice 236 to facilitate closing the second end 240 of the second orifice 236. More specifically, when a pressure differential between the pressurized fuel in the pumping chamber 210 and pressurized fuel in the fuel gallery 220 exceeds the pressure of fuel required to displace the second spring member 254, the second T-shaped valve 218 is displaced towards the fuel gallery 220 against the resistive force of the second spring member 254. The displacement of the second T-shaped valve 218 towards the fuel gallery 220 causes the second orifice 236 that is defined in the orifice plate 222 to open due to an algebraic difference in pressure of fuel between fuel in the pumping chamber 210 and fuel in the fuel gallery 220. The opening of the second orifice 236 causes pressurized fuel from the pumping chamber 210 to be channeled through the second orifice 236 to the fuel gallery 220 of the high-pressure fuel pump 200. The process of fuel flow from the pumping chamber 210 to the fuel gallery 220 of the high-pressure fuel pump 200 continues until the pressure differential between the pressurized fuel in the pumping chamber 210 and the pressurized fuel in the fuel gallery 220 decreases below the pressure of fuel required to displace the second spring member 254. Therein, the second spring member 254 is adapted to displace the second T-shaped portion 250 of the second T-shaped valve 218 against the second end 240 of the second orifice 236, thereby closing the second end 240 of the second orifice 236. The closure of the second end 240 of the second orifice 236 ensures that the pressurized fuel that is present within the pumping chamber 210 is retained within the pumping chamber 210 of the high-pressure fuel pump 200 itself without flowing to the fuel gallery 220.

In an exemplary embodiment, a spring constant of the first spring member 252 is lesser than a spring constant of the second spring member 254. More specifically, the spring constant of the first spring member 252 and the spring constant of the second spring member 254 are each user defined based on a user specific application. The spring constant of the first spring member 252 and the spring constant of the second spring member 254 are each selected by the user such that the spring constant of the first spring member 252 is lesser than the spring constant of the second spring member 254. In addition, the spring constant of the second spring member 254 is selected such that the spring constant of the second spring member 254 is slightly lesser than a spring constant of the spring member 105 of the fuel delivery valve pin 103 of the fuel delivery valve assembly 101. Since the spring constant of the second spring member 254 is slightly lesser than the spring constant of the spring member 105 of the fuel delivery valve pin 103, after the plunger 202 has attained its effective stroke length, the alignment of the helix groove 299 of the plunger 202 with the fuel inlet port 206 causes the second T-shaped valve 218 to be displaced towards the fuel gallery 220 against the resistive force of the second spring member 254. Therefore, pressurized fuel is allowed to flow from the pumping chamber 210 to the fuel gallery 220 via the second orifice 236 that is defined in the orifice plate 222. As pressurized fuel flows from the pumping chamber 210 to the fuel gallery 220 via the second orifice 236, a pressure drop results in the pumping chamber 210. As there is a drop in the pressure of fuel in the pumping chamber 210, the fuel delivery valve pin 103 closes the outlet of the pumping chamber 110 due to a restoring force exerted by the spring member 105 on the fuel delivery valve pin 103, thereby causing an end of fuel delivery of pressurized fuel from the pumping chamber 210 of the high-pressure fuel pump 200 to the fuel injector of the engine.

Therefore, the algebraic difference in pressure of fuel between the pressurized fuel in the fuel gallery 220 and the pressurized fuel in the pumping chamber 210 of the high-pressure fuel pump 200 that is required to displace the first T-shaped portion 246 of the first T-shaped valve 216 that is positioned against the first end 232 of the first orifice 230 that is defined in the orifice plate 222 towards the pumping chamber 210 is lower than the algebraic difference in pressure of fuel between the pressurized fuel in the pumping chamber 210 and the pressurized fuel in the fuel gallery 220 of the high-pressure fuel pump 200 that is required to displace the second T-shaped portion 250 of the second T-shaped valve 21g that is positioned against the second end 240 of the second orifice 236 that is defined in the orifice plate 222 towards the fuel gallery 220. A working of the high-pressure fuel pump 200 will be explained in the subsequent sections of this manuscript.

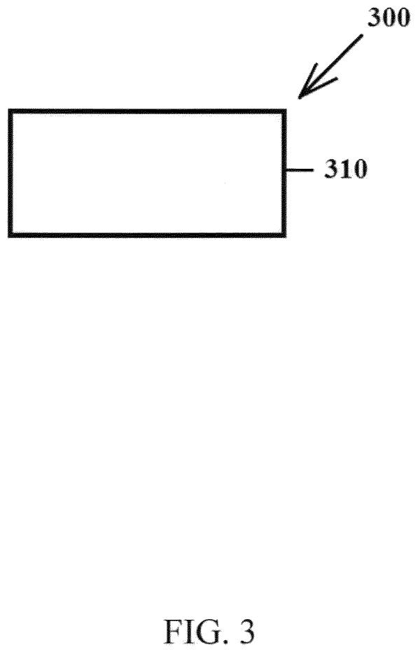

FIG. 3 is a flowchart representing a method 300 of assembling a component within a barrel 214 of a high-pressure fuel pump 200 in one embodiment of the invention. The method 300 comprises positioning 310 a first T-shaped valve 216 within a fuel inlet port 216 that is defined in the barrel 214 of the high-pressure fuel pump 200, wherein the first T-shaped valve 216 is adapted to regulate a flow of fuel between a fuel gallery 220 and a pumping chamber 210 of the high-pressure fuel pump 200.

A working of the high-pressure fuel pump 200 is now described as an example. When the plunger 202 of the high-pressure fuel pump 200 translates from its top dead center position towards its bottom dead center position, the top edge of the plunger 202 translates past the fuel inlet port 206 of the high-pressure fuel pump 200. Therein, a suction pressure is exerted in the pumping chamber 210 by the plunger 202 that translates past the fuel inlet port 206 of the high-pressure fuel pump 200. When an algebraic difference between the pressure that is exerted by pressurized fuel in the fuel gallery 220 and the suction pressure that is exerted by the plunger 202 in the pumping chamber 210 is greater than the pressure of fuel required to displace the first spring member 252 of the first T-shaped valve 216, the first T-shaped portion 246 of the first T-shaped valve 216 is displaced towards the pumping chamber 210 against the resistive force of the first spring member 252. The displacement of the first T-shaped portion 246 of the first T-shaped valve 216 towards the pumping chamber 210 opens the first end 232 of the first orifice 230. Pressurized fuel from the fuel gallery 220 is allowed to flow from the second end 234 of the first orifice 230 to the first end 232 of the first orifice 230, and to the pumping chamber 210 of the high-pressure fuel pump 200. The process of pressurized fuel flow from the fuel gallery 220 to the pumping chamber 210 of the high-pressure fuel pump 200 via the first orifice 230 continues until the plunger 202 is displaced to its bottom dead center position.

When the plunger 202 attains its bottom dead center position, the plunger 202 begins its ascent towards its top dead center position. As the plunger 202 begins ascending towards its top dead center position, the pressure of the fuel in the pumping chamber 210 begins increasing. When the algebraic difference between the pressure of the fuel that is present in the fuel gallery 220 and the pressure of the fuel that is present in the pumping chamber 210 becomes lower than the pressure of fuel required to displace the first spring member 252, the first T-shaped valve 216 is displaced towards the fuel gallery 220 due to the restoring force that is exerted by the first spring member 252 on the first T-shaped valve 216. The displacement of the first T-shaped valve 216 towards the fuel gallery 220 due to the restoring force that is exerted by the first spring member 252 on the first T-shaped valve 216 causes the first T-shaped portion 246 of the first T-shaped valve 216 to abut against the first end 232 of the first orifice 230, thereby closing the first orifice 230. Therefore, the abutment of the first T-shaped portion 246 of the first T-shaped valve 216 against the first end 232 of the first orifice 230 prevents the pressurized fuel that is present in the pumping chamber 210 from flowing to the fuel gallery 220 past the T-shaped portion 246 of the first T-shaped valve 216.

As the plunger 202 continues its ascent towards its top dead center position, the pressure of the fuel that is present in the pumping chamber 210 of the high-pressure fuel pump 200 continues increasing. Before the top edge of the plunger 202 attains a bottom edge of the fuel inlet port 206, if the algebraic difference between the pressure of the fuel that is exerted by pressurized fuel in the pumping chamber 210 and the pressure of the fuel that is exerted by pressurized fuel in the fuel gallery 220 on the second T-shaped valve 218 is greater than the pressure of fuel required to displace the second spring member 254, the second T-shaped valve 218 is displaced towards the fuel gallery 220 due to the pressurized fuel from the pumping chamber 210 that acts on the second T-shaped portion 250 of the second T-shaped valve 218. The displacement of the second T-shaped valve 218 towards the fuel gallery 220 causes the pressurized fuel from the pumping chamber 210 to flow from the first end 238 of the second orifice 236 to the second end 240 of the second orifice 236, and to the fuel gallery 220 of the high-pressure fuel pump 200. The process of fuel flow from the pumping chamber 210 to the fuel gallery 220 of the high-pressure fuel pump 200 continues until the algebraic difference between the pressure of the fuel that is exerted by pressurized fuel in the pumping chamber 210 and the pressure of the fuel that is exerted by pressurized fuel in the fuel gallery 220 is lower than the pressure of fuel required to displace the second spring member 254. When the algebraic difference between the pressure of the fuel that is exerted by pressurized fuel in the pumping chamber 210 and the pressure of the fuel that is exerted by pressurized fuel in the fuel gallery 220 on the second T-shaped valve 218 is lower than the pressure of fuel required to displace the second spring member 254, the Second T-shaped valve 218 is displaced towards the pumping chamber 210 due to the restoring force that is exerted by the second spring member 254 on the second T-shaped valve 218. The displacement of the second T-shaped valve 218 towards the pumping chamber 210 due to the restoring force that is exerted by the second spring member 254 on the second T-shaped valve 218 causes the second T-shaped portion 250 of the second T-shaped valve 218 to abut against the second end 240 of the second orifice 236, thereby closing the second orifice 236.

Before the top edge of the plunger 202 attains the bottom edge of the fuel inlet port 206, if the algebraic difference between the pressure of the fuel that is exerted by pressurized fuel in the pumping chamber 210 and the pressure of the fuel that is exerted by pressurized fuel in the fuel gallery 220 is lesser than or equal to the pressure of fuel required to displace the second spring member 254, the second T-shaped valve 218 is retained in its present position, wherein the second T-shaped portion 250 of the second T-shaped valve 218 abuts against the second end 240 of the second orifice 236, thereby closing the second orifice 236. Therefore, if the second T-shaped valve 218 is retained in its present position, wherein the second T-shaped portion 250 of the second T-shaped valve 218 abuts against the second end 240 of the second orifice 236 thereby closing the second orifice 236, no portion of the pressurized fuel from the pumping chamber 210 is allowed to flow to the fuel gallery 220 of the high-pressure fuel pump 200 past the second T-shaped portion 250 of the second T-shaped valve 218. Conversely, before the top edge of the plunger 202 attains the bottom edge of the fuel inlet port 206, if the algebraic difference between the pressure of the fuel that is exerted by pressurized fuel in the pumping chamber 210 and the pressure of the fuel that is exerted by pressurized fuel in the fuel gallery 220 is greater than the pressure of fuel required to displace the second spring member 254, the second T-shaped valve 218 is displaced from its present position, wherein the second T-shaped portion 250 of the second T-shaped valve 218 opens the second end 240 of the second orifice 236. Therefore, if the second T-shaped valve 218 is displaced towards the fuel gallery 220, a portion of the pressurized fuel from the pumping chamber 210 is allowed to flow to the fuel gallery 220 of the high-pressure fuel pump 200 past the T-shaped portion 250 of the second T-shaped valve 218.

Therefore, when the plunger 202 translates from its bottom dead center position until the top edge of the plunger 202 closes the fuel inlet port 206, all or a substantial portion of the pressurized fuel sucked into the pumping chamber 210 during the suction stroke of the plunger 202 is retained within the pumping chamber 210 of the high-pressure fuel pump 200. Therefore, when the top edge of the plunger 202 closes the fuel inlet port 206 of the high-pressure fuel pump 200, pressurized fuel at high pressure and high temperature is present within the pumping chamber 210 of the high-pressure fuel pump 200. As pressurization of fuel is caused when the plunger 202 translates from its bottom dead center position until the top edge of the plunger 202 closes the fuel inlet port 206, useful work is being done by the plunger 202 during this period of displacement of the plunger 202. As the plunger 202 performs useful work in pressurizing the fuel during the displacement of the plunger 202 from its bottom dead center position until the fuel inlet port 206 is closed by the top edge of the plunger 202, the efficiency of the high-pressure fuel pump 200 is substantially increased in comparison with a current state of the art high-pressure fuel pump 200 where no useful work is performed by the plunger 202 during the displacement of the plunger 202 from its bottom dead center position until the fuel inlet port 202 is closed by the top edge of the plunger 202.

As the plunger 202 continues its ascent towards its top dead center position after the top edge of the plunger 202 closes the fuel inlet port 206, minimum pressurization of the fuel within the pumping chamber 210 is required to cause the opening pressure of the fuel delivery valve pin 103 to be attained. This is because the opening pressure of the fuel delivery valve pin 103 is slightly greater than the pressure of fuel that is required to displace the second T-shaped valve 218 towards the fuel gallery 220 against the resistive force of the second spring member 254. When the pressure of the fuel within the pumping chamber 210 of the high-pressure fuel pump 200 attains the opening pressure of the fuel delivery valve pin 103, the fuel delivery valve pin 103 is actuated away from the pumping chamber 210 against a resistive force of its spring member 105. Pressurized fuel from the pumping chamber 210 is channeled past the fuel delivery valve pin 103 and to the fuel injector via a high-pressure fuel line. The process of fuel delivery from the pumping chamber 210 of the high-pressure fuel pump 200 to the fuel injector continues until the required quantity of pressurized fuel is delivered from the fuel injector to an engine cylinder. When an effective stroke length of the plunger 202 is attained that corresponds to the required quantity of pressurized fuel that is to be delivered from the fuel injector to the engine cylinder, the helix groove 299 of the plunger 202 becomes aligned with the fuel inlet port 206. As the pressure of fuel required to displace the second T-shaped valve 218 is slightly lower than the opening pressure of the fuel delivery valve pin 103, the pressurized fuel that flows from the pumping chamber 210 to the fuel inlet port 206 via the helix groove 299 of the plunger 202 causes the second T-shaped valve 218 to be displaced towards the fuel gallery 220 against the resistive force of the second spring member 254. The displacement of the second T-shaped valve 218 towards the fuel gallery 220 against the resistive force of the second spring member 254 causes the pressurized fuel that flows from the pumping chamber 210 to the fuel inlet port 206 via the helix groove 299 of the plunger 202 to be channeled to the fuel gallery 220 of the high-pressure fuel pump 200 past the second T-shaped portion 250 of the displaced second T-shaped valve 218.

The flow of pressurized fuel from the pumping chamber 210 to the fuel gallery 220 of the high-pressure fuel pump 200 past the second T-shaped portion 250 of the displaced second T-shaped valve 218 causes a decrease in pressure of the fuel in the pumping chamber 210 of the high-pressure fuel pump 200. The decrease in the pressure of fuel in the pumping chamber 210 of the high-pressure fuel pump 200 causes the fuel delivery valve pin 103 to close by being displaced towards the pumping chamber 210 due to the restoring force exerted by its spring member 105. As the plunger 202 continues ascending towards its top dead center position, the displacement of the plunger 202 causes the pressurized fuel that flows from the pumping chamber 210 to the fuel inlet port 206 via the helix groove 29 of the plunger 202 to be channeled to the fuel gallery 220 of the high-pressure fuel pump 200 past the second T-shaped portion 250 of the displaced second T-shaped valve 218 against a resistive force of the second spring member 254. When the plunger 202 attains its top dead center position, the pressure of residual fuel in the pumping chamber 210 decreases below the pressure of fuel required to displace the second spring member 254. The decrease in the pressure of residual fuel in the pumping chamber 218 below the pressure of fuel required to displace the second spring member 254 causes the second T-shaped valve 218 to be displaced towards the pumping chamber 210. The displacement of the second T-shaped valve 218 towards the pumping chamber 210 causes the second T-shaped portion 250 of the second T-shaped valve 218 to abut against the second end 240 of the second orifice 236, thereby closing the second orifice 236 and preventing any further flow of pressurized fuel from the pumping chamber 210 to the fuel gallery 220 of the high-pressure fuel pump 200 via a clearance defined between the second end 240 of the second orifice 236 and the second T-shaped portion 250 of the second T-shaped valve 218.

The plunger 202 of the high-pressure fuel pump 200 is displaced again from its top dead center position to its bottom dead center position, and the cycle is repeated once more. The quantity of pressurized fuel that is delivered from the pumping chamber 210 to the fuel injector is varied for each pumping stroke of the plunger 202 of the high-pressure fuel pump 200 depending on the attainment of the required effective stroke length of the plunger 202. When the effective stroke length of the plunger 202 is attained for each pumping stroke of the plunger 202 of the high-pressure fuel pump 200 which varies for each pumping stroke of the plunger 202, the helix groove 299 of the plunger 202 becomes aligned with the fuel inlet port 206 that causes the end of fuel delivery from the pumping chamber 210 of the high-pressure fuel pump 200 to the fuel injector.

A working of the high-pressure fuel pump 200 is reiterated herein for better clarity of understanding of the reader. During the suction stroke of the plunger 202 of the high-pressure fuel pump 200, the plunger 202 is displaced from its top dead center position to its bottom dead center position. Due to the suction pressure that is exerted within the pumping chamber 210 of the high-pressure fuel pump 200 by the plunger 202, the algebraic pressure difference between the pressure of fuel present in the fuel gallery 220 and the pressure of fuel present in the pumping chamber 210 of the high-pressure fuel pump 200 measured in terms of force acting on the first spring member 252 exceeds the force required to displace the first spring member 252, causing the first i-shaped portion 246 of the first T-shaped valve 216 to be displaced towards the pumping chamber 210 thereby opening the first end 232 of the orifice plate 222 to the pumping chamber 210. The displacement of the first T-shaped valve 216 towards the pumping chamber 210 causes the pressurized fuel that is present within the fuel gallery 220 of the high-pressure fuel pump 200 to flow to the pumping chamber 210 past the clearance between the first T-shaped portion 246 and the first end 232 of the orifice plate 222 against the resistive force of the first spring member 252. The spring constant of the first spring member 252 is lower in comparison with the spring constant of the second spring member 254, thereby resulting in a smooth flow of pressurized fuel from the fuel gallery 220 to the pumping chamber 210 of the high-pressure fuel pump 200 via the first T-shaped valve 216.

The flow of pressurized fuel from the fuel gallery 220 to the pumping chamber 210 continues until the plunger 202 attains its bottom dead center position due to the suction pressure that is exerted by the plunger 202 within the pumping chamber 210 of the high-pressure fuel pump 200. When the plunger 202 begins its ascent towards its top dead center position, the pressure of the fuel within the pumping chamber 210 of the high-pressure fuel pump 200 begins increasing. When the algebraic difference in the pressure of the pressurized fuel that is present within the fuel gallery 220 and the pressure of the pressurized fuel that is present within the pumping chamber 210 of the high-pressure fuel pump 200 decreases below the pressure of fuel required to displace the first spring member 252, the first T-shaped portion 246 of the first T-shaped valve 216 abuts against the first end 232 of the first orifice 230 thereby closing the first orifice 230 due to the restoring force of the first spring member 252.

The fuel that is present within the pumping chamber 210 of the high-pressure fuel pump 200 begins to pressurize from this point until the algebraic pressure difference between the pressure of fuel that is present in the pumping chamber 210 and the pressure of fuel that is present in the fuel gallery 220 of the high-pressure fuel pump 200 exceeds the pressure of fuel required to displace the second spring member 254. When the algebraic pressure difference between the pressure of fuel that is present in the pumping chamber 210 and the pressure of fuel that is present in the fuel gallery 220 of the high-pressure fuel pump 200 exceeds the pressure of fuel required to displace the second spring member 254, the second T-shaped valve 218 is displaced towards the fuel gallery 220 against the resistive force of the second spring member 254. Due to the algebraic difference in pressure of the pressurized fuel that is present in the pumping chamber 210 and the pressure of the pressurized fuel that is present in the fuel gallery 220 of the high-pressure fuel pump 200 exceeding the pressure of fuel required to displace the second spring member 254 and the corresponding displacement of the second T-shaped valve 218 towards the fuel gallery 220, the pressurized fuel that is present within the pumping chamber 210 is channeled to the fuel gallery 220 of the high-pressure fuel pump 200 past the clearance between the second T-shaped portion 250 of the second T-shaped valve 218 and the second end 240 of the second orifice 236 against the resistive force of the second spring member 254.

This process of pressurized fuel delivery from the pumping chamber 210 to the fuel gallery 220 of the high-pressure fuel pump 200 continues until the top edge of the plunger 202 closes the fuel inlet port 206. When the top edge of the plunger 202 closes the fuel inlet port 206, the pressure of the fuel that is present within the pumping chamber 210 of the high-pressure fuel pump 200 is substantially equal to an opening pressure of the second T-shaped valve 218 that is displaced towards the fuel gallery 220 against the resistive force of the second spring member 254. Due to an absence of pressurized fuel from the pumping chamber 210 acting on the second T-shaped portion 250 of the second T-shaped valve 218, when the plunger 202 closes the fuel inlet port 206, there is a pressure drop in the fuel inlet port 206 adjacent to the second T-shaped portion 250 of the second T-shaped valve 218 that causes the second T-shaped portion 250 of the second T-shaped valve 218 to be displaced towards the pumping chamber 210 due to the restoring force of the second spring member 254 acting on the second T-shaped valve 218. Moreover, at the point when the top edge of the plunger 202 closes the fuel inlet port 206, the pressure and the temperature of fuel that is present within the pumping chamber 210 is much higher than the pressure and the temperature of fuel that is present within the fuel gallery 220 of the high-pressure fuel pump 200.

As the plunger 202 continues its ascent towards its top dead center position, the pressure of fuel that is present within the pumping chamber 210 of the high-pressure fuel pump 200 increases marginally to become equal to the opening pressure of the fuel delivery valve pin 103. When the pressure of fuel that is present in the pumping chamber 210 of the high-pressure fuel pump 200 exceeds the opening pressure of the fuel delivery valve pin 103, the fuel delivery valve pin 103 is lifted upwardly against the resistive force of its spring member 105. Pressurized fuel from the pumping chamber 210 of the high-pressure fuel pump 200 flows to the fuel injector and past the fuel delivery valve pin 103 and via the fuel outlet path that is defined between the fuel delivery valve pin 103 and the fuel injector respectively. The flow of pressurized fuel from the pumping chamber 210 to the fuel injector past the fuel delivery valve pin 103 continues until the effective stroke length of the plunger 202 has been attained.

When the effective stroke length of the plunger 202 has been attained, the helix groove 299 of the plunger 202 becomes aligned with the fuel inlet port 206 due to the action of the mechanical governor that is mechanically coupled to the plunger 202 of the high-pressure fuel pump 200. Due to the algebraic difference in pressure of the pressurized fuel that is present in the pumping chamber 210 and the pressurized fuel that is present in the fuel gallery 220 of the high-pressure fuel pump 200 exceeding the pressure of fuel required to displace the second spring member 254, and that the spring constant of the second spring member 254 being slightly lesser the spring constant of the spring member 105 and consequently the opening pressure of the fuel delivery valve pin 103, the fuel delivery valve pin 103 closes, thereby preventing any further flow of pressurized fuel from the pumping chamber 210 of the high-pressure fuel pump 200 to the fuel injector via the fuel outlet path.

The pressurized fuel that is present within the pumping chamber 210 is allowed to flow to the fuel gallery 220 of the high-pressure fuel pump 200 via the helix groove 299 and via the clearance between the second end 240 of the orifice plate 222 and the second T-shaped portion 250 of the second T-shaped valve 218 due to the displacement of the second T-shaped valve 218 towards the fuel gallery 220 against the resistive force of the second spring member 254. This process of fuel delivery from the pumping chamber 210 to the fuel gallery 220 of the high-pressure fuel pump 200 continues from when the plunger 202 attains its effective stroke length until the plunger 202 attains its top dead center position.

When the plunger 202 attains its top dead center position, the algebraic difference in pressure between the pressurized fuel that is present in the pumping chamber 210 and the pressurized fuel that is present in the fuel gallery 220 of the high-pressure fuel pump 200 decreases below the pressure of fuel required to displace the second spring member 254. Therefore, the second T-shaped valve 218 is displaced towards the pumping chamber 210 due to the restoring force of the second spring member 254 on the second T-shaped valve 218. High temperature residual fuel is now retained within the pumping chamber 210 of the high-pressure fuel pump 200 between the top edge of the plunger 202 and the cylinder head when the plunger 202 attains its top dead center position, which can be utilized during the subsequent pressurization stroke of the plunger 202 of the high-pressure fuel pump 200. This residual fuel that is present between the top edge of the plunger 202 and the cylinder head when the plunger 202 attains its top dead center position is not channeled to the fuel gallery 220 via the fuel inlet port 206, thereby enhancing a thermal efficiency of the high-pressure fuel pump 200.

The advantages of the T and inverse T-shaped valve 204 that are positioned within the fuel inlet port 206 of the high-pressure fuel pump 200 are now outlined below for the understanding of the reader. The pressurization of fuel present within the pumping chamber 210 of the high-pressure fuel pump 200 begins much before the fuel inlet port 206 is closed by the top edge of the plunger 202. Therefore, due to the pressurization of the fuel within the pumping chamber 210 of the high-pressure fuel pump 200 that begins much before the fuel inlet port 206 is closed by the top edge of the plunger 202, the span of the plunger 202 between its top dead center position and its bottom dead center position may be substantially decreased. The decrease in the span of the plunger 202 between its top dead center position and its bottom dead center position leads to a reduction in a length of the barrel 214 and the housing 112 of the high-pressure fuel pump 200 respectively.

In addition, as useful work is being performed by the plunger 202 from when the plunger is displaced from its bottom dead center position until the fuel inlet port 206 is closed by the top edge of the plunger 202 during its ascent towards its top dead center position, the mechanical efficiency of the high-pressure fuel pump 200 is substantially increased. Moreover, the longitudinal length of the plunger 202 may be significantly decreased as the pressurization of the fuel in the pumping chamber 210 by the plunger 202 is minimal after the top edge of the plunger 202 closes the fuel inlet port 206 that is defined in the barrel 214 of the high-pressure fuel pump 200. More specifically, the helix groove 299 that is defined in the plunger 202 may originate from proximate the top edge of the plunger 202 of the high-pressure fuel pump 200 itself and not from a finite displacement below the top edge of the plunger 202, thereby resulting in material cost savings associated with manufacturing a plunger 202 of a decreased longitudinal length.

The further advantages of the T and inverse T-shaped valve 204 that are positioned within the fuel inlet port 206 of the high-pressure fuel pump 200 are that owing to the high temperature residual fuel that is retained within the pumping chamber 210 after the plunger 202 attains its top dead center position, the energy expended by the roller tappet to raise the temperature of fuel during the subsequent pressurization stroke of the plunger 202 is substantially decreased. Moreover, the work expended by the roller-tappet is significantly decreased as pressurization of the fuel in the pumping chamber 210 occurs when the plunger 202 is displaced from its bottom dead center position until the fuel inlet port 206 is closed by the top edge of the plunger 202 over a long span of the plunger 202, and fuel delivery of the fuel in the pumping chamber 210 begins from when the top edge of the plunger 202 closes the fuel inlet port 206 and translates upwardly by a small displacement until the plunger 202 is translated to its effective stroke length.

Further, the material cost savings associated with manufacturing a plunger 202 of a smaller stroke length, a smaller barrel 214, and a smaller housing 112 of the high-pressure fuel pump 200 for the same quantity of pressurized fuel that is required to be delivered from the pumping chamber 210 to the fuel injector as is currently being delivered by means of a state of the art high-pressure fuel pump is significantly higher. Furthermore, cavitation resulting from channeling high temperature residual pressurized fuel from the pumping chamber 210 to the fuel gallery 220 of the high-pressure fuel pump 200 and channeling the complete quantity of low pressure fuel back from the fuel gallery 220 to the pumping chamber 210 of the high-pressure fuel pump 200 may be avoided by the implementation of the T and inverse T-shaped valve 204 in the fuel inlet port 206 of the high-pressure fuel pump 200.

Exemplary embodiments of a T and inverse T-shaped valve 204 positioned within a fuel inlet port 206 of a high-pressure fuel pump 200 are described above in detail. The systems are not limited to the specific embodiments described herein, but rather, components of each system may be utilized separately and independently from other components described herein. In addition, the terms ‘fuel injection pump’ and ‘high-pressure fuel pump’ may be used interchangeably herein. Moreover, the terms ‘displaced’ and ‘translated’ with respect to the plunger 202 may be used interchangeably herein. Furthermore, the terms ‘abut’ and ‘flush’ may be used interchangeably herein in this manuscript.

While the invention has been described in terms of various specific embodiments, those skilled in the art will recognize that the invention can be practiced with modifications within the spirit and scope of the claims.

1. A high-pressure fuel pump, said high-pressure fuel pump comprising:
a housing;
a barrel positioned within said housing;
a plunger positioned in a pumping chamber defined within said barrel, said plunger adapted to reciprocate within the pumping chamber to facilitate delivering pressurized fuel from the pumping chamber to at least one fuel injector; and
a first T-shaped valve comprising a stem portion that is inserted through an orifice defined within a fuel inlet port that is defined in said barrel of said high-pressure fuel pump and a T-shaped portion formed at an end of said stem portion of said first T-shaped valve, said T-shaped portion adjoining said stem portion of said first T-shaped valve positioned flush against the orifice thereby closing the orifice, said first T-shaped valve adapted to regulate a flow of fuel between a fuel gallery and the pumping chamber of said high-pressure fuel pump.

2. The high-pressure fuel pump in accordance with claim 1, further comprising a second T-shaped valve positioned within the fuel inlet port that is defined in said barrel of said high-pressure fuel pump, said second T-shaped valve adapted to regulate the flow of fuel between the pumping chamber and the fuel gallery of said high-pressure fuel pump.

3. The high-pressure fuel pump in accordance with claim 2, wherein the fuel inlet port that is defined in said barrel is located between the fuel gallery and the pumping chamber of said high-pressure fuel pump.

4. The high-pressure fuel pump in accordance with claim 3, further comprising an orifice plate positioned within the fuel inlet port and secured thereto, the orifice plate comprising a first orifice defined in said orifice plate and located between the fuel gallery and the pumping chamber of said high-pressure fuel pump, and a second orifice defined in said orifice plate and located between the pumping chamber and the fuel gallery of said high-pressure fuel pump.

5. The high-pressure fuel pump in accordance with claim 4, wherein said first T-shaped valve is inserted through the first orifice defined in said orifice plate and reciprocates within the first orifice to facilitate regulating the flow of fuel from the fuel gallery to the pumping chamber of said high-pressure fuel pump, and said second T-shaped valve is inserted through the second orifice defined in said orifice plate and reciprocates within the second orifice to facilitate regulating the flow of fuel from the pumping chamber to the fuel gallery of said high-pressure fuel pump.

6. The high-pressure fuel pump in accordance with claim 5, wherein a direction of orientation of said second T-shaped valve is opposite to a direction of orientation of said first T-shaped valve.

7. The high-pressure fuel pump in accordance with claim 5, wherein said first T-shaped valve is adapted to open/close the first orifice thereby regulating the flow of fuel from the fuel gallery to the pumping chamber of said high-pressure fuel pump, and wherein said second T-shaped valve is adapted to open/close the second orifice thereby regulating the flow of fuel from the pumping chamber to the fuel gallery of said high-pressure fuel pump.

8. The high-pressure fuel pump in accordance with claim 7, further comprising a first spring member positioned between the first orifice defined in said orifice plate and a first T-shaped portion of said first T-shaped valve, and a second spring member positioned between the second orifice defined in said orifice plate and a second T-shaped portion of said second T-shaped valve, wherein said first spring member is adapted to displace said first T-shaped portion of said first T-shaped valve against the first orifice thereby closing the first orifice of said orifice plate, and wherein said second spring member is adapted to displace said second T-shaped portion of said second T-shaped valve against the second orifice thereby closing the second orifice of said orifice plate.

9. The high-pressure fuel pump in accordance with claim 8, wherein said first T-shaped valve is adapted to be displaced towards the pumping chamber against a resistive force of said first spring member to open the first orifice defined in said orifice plate due to a difference in pressure of fuel between fuel in the fuel gallery and fuel in the pumping chamber, thereby allowing fuel to be channeled from the fuel gallery to the pumping chamber of said high-pressure fuel pump.

10. The high-pressure fuel pump in accordance with claim 8, wherein said second T-shaped valve is adapted to be displaced towards the fuel gallery against a resistive force of said second spring member to open the second orifice defined in said orifice plate due to a difference in pressure of fuel between fuel in the pumping chamber and fuel in the fuel gallery, thereby allowing fuel to be channeled from the pumping chamber to the fuel gallery of said high-pressure fuel pump.

11. The high-pressure fuel pump in accordance with claim 8, wherein a spring constant of said first spring member is lesser than a spring constant of said second spring member such that a difference in pressure of fuel between fuel in the fuel gallery and fuel in the pumping chamber of said high-pressure fuel pump that is required to displace said first T-shaped portion of said first T-shaped valve that is positioned against the first orifice defined in said orifice plate is lesser than a difference in pressure of fuel between fuel in the pumping chamber and fuel in the fuel gallery of said high-pressure fuel pump that is required to displace said second T-shaped portion of said second T-shaped valve that is positioned against the second orifice defined in said orifice plate.

12. A barrel positioned within a housing of a high-pressure fuel pump, said barrel comprising a first T-shaped valve comprising a stem portion that is inserted through an orifice defined within a fuel inlet port that is defined in said barrel of said high-pressure fuel pump and a T-shaped portion formed at an end of said stem portion of said first T-shaped valve, said T-shaped portion adjoining said stem portion of said first T-shaped valve positioned flush against the orifice thereby closing the orifice, said first T-shaped valve adapted to regulate a flow of fuel between a fuel gallery and a pumping chamber of said high-pressure fuel pump.

13. The barrel positioned within said housing of said high-pressure fuel pump in accordance with claim 12, further comprising a second T-shaped valve positioned within the fuel inlet port that is defined in said barrel of said high-pressure fuel pump, said second T-shaped valve adapted to regulate the flow of fuel between the pumping chamber and the fuel gallery of said high-pressure fuel pump.

14. The barrel positioned within said housing of said high-pressure fuel pump in accordance with claim 13, wherein the fuel inlet port that is defined in said barrel is located between the fuel gallery and the pumping chamber of said high-pressure fuel pump.

15. The barrel positioned within said housing of said high-pressure fuel pump in accordance with claim 14, further comprising an orifice plate positioned within the fuel inlet port and secured thereto, the orifice plate comprising a first orifice defined in said orifice plate and located between the fuel gallery and the pumping chamber of said high-pressure fuel pump, and a second orifice defined in said orifice plate and located between the pumping chamber and the fuel gallery of said high-pressure fuel pump.

16. The barrel positioned within said housing of said high-pressure fuel pump in accordance with claim 15, wherein said first T-shaped valve is inserted through the first orifice defined in said orifice plate and reciprocates within the first orifice to facilitate regulating the flow of fuel from the fuel gallery to the pumping chamber of said high-pressure fuel pump, and said second T-shaped valve is inserted through the second orifice defined in said orifice plate and reciprocates within the second orifice to facilitate regulating the flow of fuel from the pumping chamber to the fuel gallery of said high-pressure fuel pump.

17. The barrel positioned within said housing of said high-pressure fuel pump in accordance with claim 16, wherein a direction of orientation of said second T-shaped valve is opposite to a direction of orientation of said first T-shaped valve.

18. The barrel positioned within said housing of said high-pressure fuel pump in accordance with claim 16, wherein said first T-shaped valve is adapted to open/close the first orifice thereby regulating the flow of fuel from the fuel gallery to the pumping chamber of said high-pressure fuel pump, and wherein said second T-shaped valve is adapted to open/close the second orifice thereby regulating the flow of fuel from the pumping chamber to the fuel gallery of said high-pressure fuel pump.

19. The barrel positioned within said housing of said high-pressure fuel pump in accordance with claim 18, further comprising a first spring member positioned between the first orifice defined in said orifice plate and a first T-shaped portion of said first T-shaped valve, and a second spring member positioned between the second orifice defined in said orifice plate and a second T-shaped portion of said second T-shaped valve, wherein said first spring member is adapted to displace said first T-shaped portion of said first T-shaped valve against the first orifice thereby closing the first orifice of said orifice plate, and wherein said second spring member is adapted to displace said second T-shaped portion of said second T-shaped valve against the second orifice thereby closing the second orifice of said orifice plate.

20. The barrel positioned within said housing of said high-pressure fuel pump in accordance with claim 19, wherein said first T-shaped valve is adapted to be displaced towards the pumping chamber against a resistive force of said first spring member to open the first orifice defined in said orifice plate due to a difference in pressure of fuel between fuel in the fuel gallery and fuel in the pumping chamber, thereby allowing fuel to be channeled from the fuel gallery to the pumping chamber of said high-pressure fuel pump.

21. The barrel positioned within said housing of said high-pressure fuel pump in accordance with claim 19, wherein said second T-shaped valve is adapted to be displaced towards the fuel gallery against a resistive force of said second spring member to open the second orifice defined in said orifice plate due to a difference in pressure of fuel between fuel in the pumping chamber and fuel in the fuel gallery, thereby allowing fuel to be channeled from the pumping chamber to the fuel gallery of said high-pressure fuel pump.

22. The barrel positioned within said housing of said high-pressure fuel pump in accordance with claim 19, wherein a spring constant of said first spring member is lesser than a spring constant of said second spring member such that a difference in pressure of fuel between fuel in the fuel gallery and fuel in the pumping chamber of said high-pressure fuel pump that is required to displace said first T-shaped portion of said first T-shaped valve that is positioned against the first orifice defined in said orifice plate is lesser than a difference in pressure of fuel between fuel in the pumping chamber and fuel in the fuel gallery of said high-pressure fuel pump that is required to displace said second T-shaped portion of said second T-shaped valve that is positioned against the second orifice defined in said orifice plate.

23. A method of assembling a component within a barrel of a high-pressure fuel pump, the method comprising:
inserting the component comprising a T-shaped valve that comprises a stem portion through an orifice defined within a fuel inlet port that is defined in the barrel of the high-pressure fuel pump, forming a T-shaped portion at an end of the stem portion of the T-shaped valve, and positioning the T-shaped portion adjoining the stem portion of the T-shaped valve flush against the orifice thereby closing the orifice, wherein the T-shaped valve is adapted to regulate a flow of fuel between a fuel gallery and a pumping chamber of the high-pressure fuel pump.
